(19) United States
(12) Patent Application Publication
(10) Pub. No.: US 2026/0253152 A1
(43) Pub. Date: Aug. 27, 2026

(54) DISASTER RESPONSE TRAINING DEVICE

(71) Applicant: Nippon Telegraph and Telephone Corporation, Tokyo (JP)

(72) Inventors: Tsuneko Kura, Musashino-shi, Tokyo (JP); Naoko KOSAKA, Musashino-shi, Tokyo (JP); Hiroshi MATSUBARA, Musashino-shi, Tokyo (JP); Masaki HISADA, Musashino-shi, Tokyo (JP)

(21) Appl. No.: 18/876,943

(22) PCT Filed: Jun. 21, 2022
(86) PCT No.: PCT/JP2022/024670

§ 371 Date: Dec. 19, 2024

(51) Int. Cl. G06Q 50/163; G06Q 50/26

(52) U.S. Cl. CPC G06Q 50/163; G06Q 50/265

(57) ABSTRACT

A disaster response training device 1 includes: a processing unit 121 that processes damage caused by a past disaster that has occurred in a predetermined area and a response policy as a scenario; a first calculation unit 123 that calculates a current number of people staying in the predetermined area; a second calculation unit 124 that calculates current damage to real estate in the predetermined area; a third calculation unit 125 that calculates current disaster response resources in the predetermined area; a display unit 126 that displays, on a screen, the damage caused by the past disaster and the response policy, the current number of people staying, the current damage to the real estate, and the current disaster response resources; and a request unit 127 that requests a user to provide a current response policy based on the current number of people staying, the current damage to the real estate, and the current disaster response resources on the basis of the response policy of the scenario.

### TECHNICAL FIELD

The present invention relates to a disaster response training device.

### BACKGROUND ART

In Japan, damage due to heavy rain, typhoons, and the like, occurs every year. In various organizations such as national and local governments and fire departments, disaster prevention plans are prepared in order to cope with a disaster that has occurred, and therefore, on-map training for coping with the disaster is conducted (Non Patent Literature 1). In addition, there are organizations, and the like, that support on-map training, and efforts have been made to improve regional disaster prevention (Non Patent Literature 2).

As actual response, a system capable of making a decision in consideration of past disaster data, and the like, in addition to an external damage condition has also been developed (Non Patent Literature 3). In addition, a device that formulates a recovery plan related to disaster response has also been studied (Patent Literature 1).

### CITATION LIST

### Patent Literature

Patent Literature 1: JP 2022-013392 A

### Non Patent Literature

Non Patent Literature 1: “Disaster Management Plan”, the Cabinet Office [online], retrieved on Jun. 9, 2022<URL: http://www.bousai.go.jp/taisaku/keikaku/kihon.html>
Non Patent Literature 2: “Disaster Prevention On-map Training”, Institute of Scientific Approaches for Fire & Disaster [online], retrieved on Jun. 9, 2022<URL: https://www.isad.or.jp/to_municipalities/disaster_preventio n_map/>
Non Patent Literature 3: “Municipal Disaster Coping Integrated System Development”, Research Center for National Disaster Resilience [online], retrieved on Jun. 9, 2022<URL: https://www.bosai.go.jp/nr/nr7.html>

### SUMMARY OF INVENTION

### Technical Problem

In on-map training, a training scenario is determined in advance, each person in charge considers a response policy while analyzing a condition according to the assigned condition as appropriate, and finally, the response policy is determined at a meeting where a decision maker attends. However, the condition is assigned on the basis of a hypothesis without a real state such as buildings, facilities, or movement of persons being reflected, and thus, there is a possibility that the training scenario may be the same old training scenario, and the condition may be far from that when a disaster actually occurs.

In addition, Non Patent Literature 3 only acquires information on the weather, rivers, and the like, of the area in real time, adds and analyzes information on disaster response in addition to the past disaster data of the area, obtains a risk index matching characteristics of the area and provides the risk index to the decision maker.

In either case, the past disaster response experience was possessed by individual and was not actively presented to the related persons, and thus, the related persons could not evaluate the past response policy, and points to be improved, know-how, and the like, regarding the response were not utilized for disaster response.

In addition, Patent Literature 1 only obtains a difference between a magnitude of damage caused by a disaster predicted in advance and a magnitude of damage actually occurred for a plurality of facilities and determines a recovery task based on the difference. In this case, it is not determined as to whether or not the set recovery task has been appropriate after the disaster has occurred, and thus, there is a possibility that the recovery task may not be updated although the response is insufficient.

The present invention has been made in view of the above circumstances, and an object of the present invention is to provide a technique capable of providing disaster response training in a form close to reality.

### Solution to Problem

A disaster response training device according to an aspect of the present invention includes: a processing unit that processes damage caused by a past disaster that has occurred in a predetermined area and a response policy as a scenario; a first calculation unit that calculates a current number of people staying in the predetermined area; a second calculation unit that calculates current damage to real estate in the predetermined area; a third calculation unit that calculates current disaster response resources in the predetermined area; a display unit that displays, on a screen, the damage caused by the past disaster and the response policy, the current number of people staying, the current damage to the real estate, and the current disaster response resources; and a request unit that requests a user to provide a current response policy based on the current number of people staying, the current damage to the real estate, and the current disaster response resources on the basis of the response policy of the scenario.

### Advantageous Effects of Invention

According to the present invention, it is possible to provide a technique capable of providing disaster response training in a form close to reality.

### BRIEF DESCRIPTION OF DRAWINGS

FIG. 1 is a view illustrating an overall configuration of a disaster response training system.

FIG. 2 is a view indicating an example of past disaster response.

FIG. 3A is a view indicating processing flow of a disaster response training device.

FIG. 3B is a view indicating processing flow of the disaster response training device.

FIG. 4 illustrates a hardware configuration example of the disaster response training device.

### DESCRIPTION OF EMBODIMENTS

An embodiment of the present invention will be described below with reference to the drawings. In the drawings, the same parts are denoted by the same reference signs, and description thereof will be omitted.

### SUMMARY OF INVENTION

The present invention relates to a technique of providing disaster response training in a form close to reality by reflecting current conditions of buildings, infrastructures, resources held, population ratio, and the like, using disaster response performed against past disasters as a basis of a scenario.

Specifically, a condition of the disaster occurring in the past and response action performed at that time are set as a scenario, and change from the time of occurrence is input as external information. As a result, it is possible to perform disaster response training in a state close to the current condition.

Specifically, a degree of risk of a building or a facility is determined on the basis of a material, a structure, aging and a geographical condition of the building or facility, and influence in accordance with a type of the disaster. As a result, it is possible to perform training in a form close to the damage assumed to occur in the current condition.

Specifically, the number of people staying at the time point of the training is estimated on the basis of a people flow service. As a result, it is possible to perform training in a form close to the damage assumed to occur in the current condition.

Further, specifically, the past damage condition and the policy for responding thereto are displayed at the time of training. This makes it possible to utilize know-how of predecessors when considering the response policy.

### [Configuration of Disaster Response Training System 1]

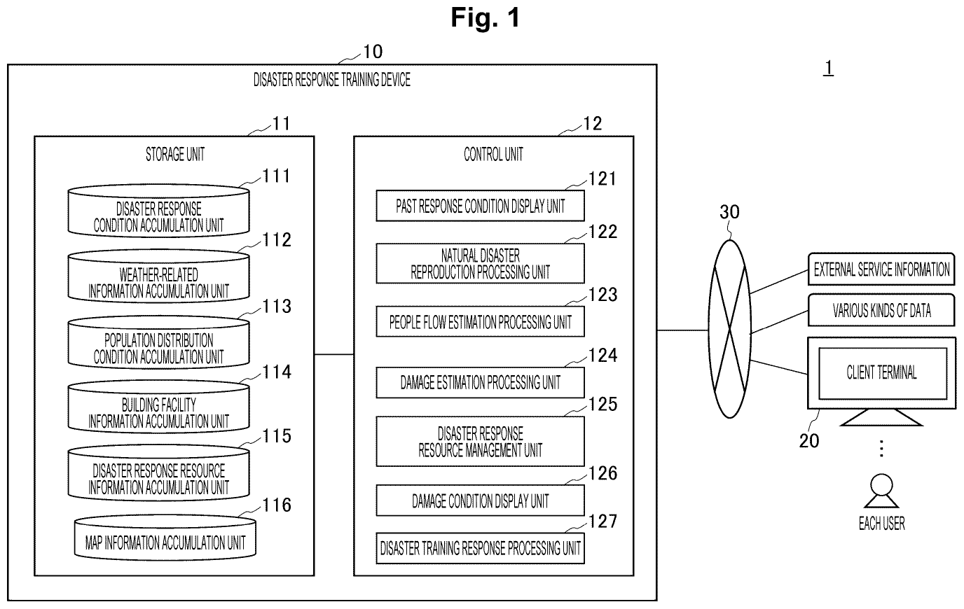

FIG. 1 is a view illustrating an overall configuration of a disaster response training system 1 according to the present embodiment.

The disaster response training system 1 includes a disaster response training device 10 and a plurality of client terminals 20. The disaster response training device 10 is communicably connected to the client terminal 20 of each user via a communication network 30. The client terminal 20 is a personal computer, a tablet terminal, a mobile phone, or the like.

### [Configuration of Disaster Response Training Device 10]

The disaster response training device 10 includes a storage unit 11 and a control unit 12.

The storage unit 11 includes a disaster response condition accumulation unit 111, a weather-related information accumulation unit 112, a population distribution condition accumulation unit 113, a building facility information accumulation unit 114, a disaster response resource information accumulation unit 115, and a map information accumulation unit 116.

The control unit 12 includes a past response condition display unit 121, a natural disaster reproduction processing unit 122, a people flow estimation processing unit 123, a damage estimation processing unit 124, a disaster response resource management unit 125, a damage condition display unit 126, and a disaster training response processing unit 127.

### [Functions of Storage Unit 11]

The disaster response condition accumulation unit 111 has a function of storing a disaster response policy determined by each local government. In addition, the disaster response condition accumulation unit 111 has a function of storing damage information regarding past disasters, a response policy and decision matters regarding the disaster, and the like, in time series.

The weather-related information accumulation unit 112 has a function of storing information related to weather regarding past disasters. As the weather-related information, weather data disclosed outside such as the Meteorological Agency or a weather information providing company can also be used.

The population distribution condition accumulation unit 113 has a function of storing numerical values such as population, the number of households, statistical information by age, daytime population, and nighttime population in a certain unit (by town and block) of a predetermined district.

The building facility information accumulation unit 114 has a function of storing building facility information such as address of a building, the number of years of the building, a building structure (an item described in a certificate of registered matters (building), or the like), address of a facility, the number of years of the facility, repair time of the facility, and a structure of the facility.

The disaster response resource information accumulation unit 115 has a function of storing resource information to be used for disaster response. In a case of an evacuation center, address, contact address, owned equipment, the number of pieces of the owned equipment, the number of people to be accommodated, and the like, are stored. In a case of a disaster storage warehouse, address, storage product name, the number of storage products, and the like, are stored. In addition, information such as the number of water supply vehicles, heavy machine, and the like, owned by local governments, lending destinations, and periods is also stored.

The map information accumulation unit 116 has a function of storing map information of a management area of each local government.

### [Function of Control Unit 12]

The past response condition display unit (processing unit) 121 has a function of searching the disaster response condition accumulation unit 111 for the past disaster response condition in response to a request to view the past disaster response condition requested by a staff (user) of the local government and giving a search result to the damage condition display unit 126 to display the search result on the screen. In this event, the past response condition display unit 121 processes the damage by the past disaster and the response policy as a scenario.

The natural disaster reproduction processing unit 122 has a function of reproducing the past disaster at the time of disaster response training by using the weather-related information stored in the weather-related information accumulation unit 112.

The people flow estimation processing unit (first calculation unit) 123 has a function of calculating the estimated number of people staying in each town and block in the management area at the present time point during the disaster response training on the basis of external service information provided from an externally provided service such as mobile space statistics.

The damage estimation processing unit (second calculation unit) 124 has a function of calculating current strength and degrees of risk of buildings and facilities on the basis of the building facility information stored in the building facility information accumulation unit 114. In addition, the damage estimation processing unit 124 has a function of calculating influence of the past disaster on buildings and facilities by using, as inputs, strength information and risk information of the buildings and the facilities and a condition of the past disaster reproduced by the natural disaster reproduction processing unit 122. The buildings and the facilities are examples of real estate.

The disaster response resource management unit (third calculation unit) 125 has a function of calculating disaster response resources at the present time point during the disaster response training. In addition, the condition changes from moment to moment due to decision of the response policy to the disaster, such as establishment of evacuation centers and arrangement of water supply vehicles in watertight areas, and thus, the disaster response resource management unit 125 has a function of receiving change in the condition of the disaster response resources by the user and updating the disaster response resource information accumulation unit 115 to the latest disaster response resources on the basis of the received changed disaster response resources.

The damage condition display unit (display unit) 126 has a function of displaying the disaster condition assumed in the disaster response training on a screen by superimposing the past disaster response condition retrieved by the past response condition display unit 121, the past natural disaster condition reproduced by the natural disaster reproduction processing unit 122, the current condition of people staying for each town and block calculated by the people flow estimation processing unit 123, the damage condition of buildings and facilities calculated by the damage estimation processing unit 124 on the basis of the past natural disaster condition reproduced by the natural disaster reproduction processing unit 122, and the current disaster response resource information updated by the disaster response resource management unit 125 on map information of the management area of the local government stored in the map information accumulation unit 116.

The disaster training response processing unit (request unit) 127 has a function of requesting a user to provide a current disaster response policy based on the current condition of people staying for each town and block, the damage condition of buildings and facilities, and the current disaster response resource information on the basis of the response policy of the scenario.

In addition, the disaster training response processing unit 127 has a function of storing the current disaster response policy input and determined by each user on the basis of the past damage condition displayed on the damage condition display unit 126 in the disaster response condition accumulation unit 111.

At the same time, in a case where the disaster response resources are used according to the determined disaster response policy, the disaster training response processing unit 127 has a function of transmitting a usage condition of the disaster response resources to the disaster response resource management unit 125 and causing the disaster response resource management unit 125 to reflect the latest condition of the disaster response resources at that time in the disaster response resource information accumulation unit 115.

### [Detailed Function of Control Unit 12]

### (Detailed Function of Past Response Condition Display Unit 121)

### (Function of Requesting Storage/Presentation of Past Disaster Response Condition)

The past response condition display unit 121 has a function of storing the past disaster response condition in the disaster response condition accumulation unit 111 and a function of requesting presentation of the past disaster response condition. Specifically, the past response condition display unit 121 stores and presents events such as past disaster occurrence conditions and countermeasures implemented for the past disaster in time series.

For one event, various types of corresponding information are stored in a format such as date of occurrence, a response time point, a category, content of the disaster, a responder, content of damage, content of response, and others. A plurality of events which are collectively stored in time series for each event (for each response time point) are referred to as a scenario.

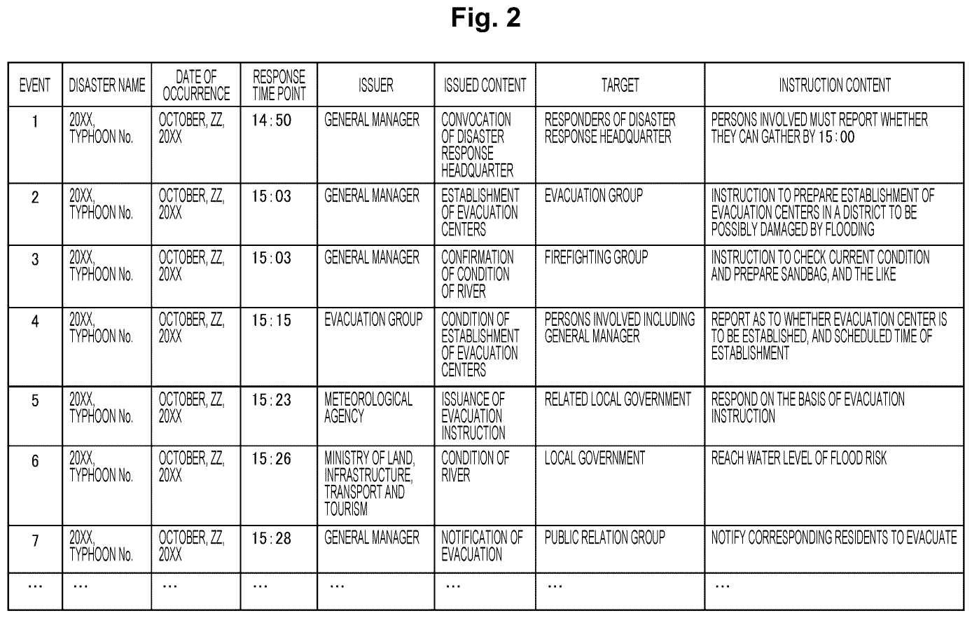

The “category” describes content deeply related to an event, such as weather information, disaster information, resource-related information, and decision-making. The “weather information” indicates an event related to an alarm or warning issued by the Meteorological Agency, or the like. The “disaster information” indicates an event related to damage caused by a disaster, such as flooding of a river or a sediment disaster. “Others” can be used as a field in which necessary information which is not applied to the setting item is stored. An example of past disaster response is indicated in FIG. 2.

The past response condition display unit 121 selects any one scenario from a plurality of scenarios at the time of disaster response training according to designation by the user. The past response condition display unit 121 sets a time point of the event described at the top of the selected scenario as a start time point and requests the damage condition display unit 126 to display information regarding the event (event 1) at that time point. Thereafter, the past response condition display unit 121 obtains a time interval from the next event (event 2) and requests the damage condition display unit 126 to display information regarding the next event (event 2) when the time interval has elapsed.

The past response condition display unit 121 transmits information on the start time point to the natural disaster reproduction processing unit 122 and reproduces the natural disaster of the designated date.

### (Detailed Function of Natural Disaster Reproduction Processing Unit 122)

### (Function of Reproducing Natural Disaster Related to Designated Date)

The natural disaster reproduction processing unit 122 has a function of reproducing a natural disaster related to designated date. Specifically, the natural disaster reproduction processing unit 122 reproduces a past natural disaster occurring on the designated date. For example, a disaster caused by a natural disaster such as a weather condition, a mudslide, or a tsunami is reproduced. The reproduction result of the reproduced natural disaster is transmitted to the damage condition display unit 126.

### (Detailed Function of People Flow Estimation Processing Unit 123)

### (Function of Estimating Staying Population)

The people flow estimation processing unit 123 has a function of estimating the population staying for each town and block at the time point of the disaster response training. Specifically, the people flow estimation processing unit 123 estimates how many people are in the area at the assumed time point from the number of people staying obtained from the external service for each town and block.

For example, if a mobile phone ownership rate is used, the estimated number of people is “estimated number of people=number of people staying/ownership rate”. For example, a ratio of the number of people in a case where the residents have self-solved instead of using the evacuation center may be obtained from the past disaster response and used. The ratio of people who come to the evacuation center may be used as an evacuation rate in the evacuation center. The estimated number of people is a numerical value including people other than the residents, but a percentage of people other than the residents actually exist is unclear. Thus, the number of people who may come to the evacuation center may be set as “the number of people who may come to the evacuation center=the estimated number of people×the evacuation rate in the evacuation center”. This numerical value is used as determination on establishment of evacuation centers. Note that the above calculation method is merely an example.

### (Detailed Function of Damage Estimation Processing Unit 124)

### (Function of Estimating Degrees of Risk of Buildings/Facilities)

The damage estimation processing unit 124 has a function of estimating degrees of risk of buildings or facilities. Specifically, the damage estimation processing unit 124 calculates strength and the degrees of risk of buildings and facilities at the present time point on the basis of various attribute information of the buildings and the facilities.

For example, if an index related to a material of a building or a facility is set as M, an index related to a structure is set as C, an index related to aging is set as T(M, C), an index related to a geographical condition is set as L(E), and influence in accordance with a type of a disaster is set as E, strength S of each building or facility against the disaster at the present time point is expressed by the following expression (1).

$$S = M \times C \times T ( M , C ) \times L ( E ) \times E \qquad ( 1 )$$

In addition, if the original strength of the building or facility is represented by So (=M×C×L), the degree of risk D of the building or facility is obtained by the following expression (2).

$$D = ( So - S ) / So \qquad ( 2 )$$

For example, for a predetermined building, in a case where the original strength So is 100 and the current strength S is 80, the current degree of risk D is 20%. The degree of risk of 20% represents a degree of possibility of occurrence of collapse, or the like, of the building at the present time point.

In addition, the damage estimation processing unit 124 recalculates the strength of the building or facility after the disaster response is performed. If an elapsed period from the start of a work period to the time point is set as t with respect to the assumed work period P for disaster response, a recovery rate is obtained as t/P. Thus, the strength S′ at the time point is expressed by the following expression (3).

$${S}^{′} = S + t ( So - S ) / P \qquad ( 3 )$$

The degree of risk D′ in this case is obtained by the following expression (4).

$${D}^{′} = ( So - {S}^{′} ) / P \qquad ( 4 )$$

### (Function of Estimating Damage of Buildings/Facilities)

In addition, the damage estimation processing unit 124 has a function of estimating damage of buildings and facilities.

Specifically, there is a possibility that the degree of risk D obtained at the present time point is different from the degree of risk based on the strength at the time of occurrence of the past disaster, and thus, the damage estimation processing unit 124 estimates damage to buildings and facilities on the basis of the past disaster reproduction result by the natural disaster reproduction processing unit 122.

For example, the damage estimation processing unit 124 determines degrees of damage of buildings and facilities within a certain range of the degree of risk on the basis of the past disaster reproduction results. As an example, a building having a high degree of risk D of collapse within a range of 80% to 100% at the present time point is extracted, and the estimated degree of damage to the building is determined on the basis of the influence of flooding of a river or a sediment disaster occurring in the past on the extracted building. The determined degree of damage is transmitted to the disaster training response processing unit 127.

In addition, the damage estimation processing unit 124 estimates the damage after the disaster response is performed by input of the response policy from the disaster training response processing unit 127 or input of the disaster response resource management unit 125. For example, the damage estimation processing unit 124 obtains a period required for recovery processing on the basis of the past disaster response record and estimates the damage at that time point for the next report timing.

### (Detailed Function of Disaster Response Resource Management Unit 125)

### (Function of Changing Resource Condition)

The disaster response resource management unit 125 has a function of changing a resource condition of disaster response. Specifically, the disaster response resource management unit 125 updates management information of the resources in a case where it is necessary to move the disaster response resources on the basis of the response policy determined in the disaster response training, or the like.

For example, in a case of a lent resource, information of a lending destination (location information such as address, person in charge of lending destination, an estimated period, etc.) and the number of lent resources are recorded. The available number is “available number=current number−number of lent resources”, and thus, if the available number>0, it is possible to lend the resource to another place.

For example, in a case of a returned resource, the return date is recorded. In addition, the available number=the current number+the returned number.

For example, in a case where the resource is a consumable item such as water or food, information on a carry-out destination (location information such as address, person in charge of the carry-out destination) and the number of carried out items are recorded. The number that can be carried out is “the number of items that can be carried out=the current number of items−the number of carried out items”, and thus, if the number of items that can be carried out>0, the items can be carried out to another place.

The number of people evacuated is reported from each evacuation center, and thus, the number of items to be carried out is set as “the number of items to be carried out=the number of residents in the target area+ (the number of evacuees−the number of residents)×α”. Distribution of items corresponding to the number of residents is based on the assumption of family members staying at home and living in evacuation. In addition, persons who do not live in the area are “persons who do not live in the area=the number of evacuees−the number of residents”, but there is a possibility that the number will increase in the future, and thus, this is multiplied by an increase coefficient α. α is a value set by each local government on the basis of past experience. A method for obtaining the number of items to be carried out is merely an example, and is not uniquely determined.

For example, in a case where consumables are provided from the local government or a business operator that is an external cooperation partner, information (location information such as address, provider name) of the provision destination and the number of provided items are recorded. The number of items that can be carried out is “number of items that can be carried out=current number+provided number”.

### (Detailed Function of Damage Condition Display Unit 126)

### (Function of Displaying Disaster Condition for Training)

The damage condition display unit 126 has a function of displaying a disaster condition for disaster response training. Specifically, the damage condition display unit 126 displays content of the next event on the screen at the time point when a period until occurrence of the next event has elapsed from a certain event according to the selected scenario.

For example, the reproduction result of the natural disaster transmitted from the natural disaster reproduction processing unit 122 is displayed on a map.

For example, the estimated number of people staying in the area transmitted from the people flow estimation processing unit 123 is displayed on the map.

For example, “weather information” or “disaster information” is displayed in the category. However, in a case where new damage prediction obtained by the damage estimation processing unit 124 on the basis of the information of the building facility information accumulation unit 114 is used, the damage information at the present time point is displayed at the above-described time point when the period has elapsed.

For example, the latest disaster response resource condition read from the disaster response resource management unit 125 is displayed as attribute information at the position of the corresponding resource.

For example, past response information transmitted from the past response condition display unit 121 is displayed as reference information.

For example, the response policy determined by the disaster training response processing unit 127 is displayed when a corresponding building, facility, or the like, is designated.

### (Detailed Function of Disaster Training Response Processing Unit 127)

### (Function of Registering Response Policy)

The disaster training response processing unit 127 has a function of registering a disaster response policy determined by the user. Specifically, the disaster training response processing unit 127 determines a disaster response policy on the basis of the natural disaster and the damage estimation condition indicated by the damage condition display unit 126 and registers necessary information in accordance with the determined disaster response policy. The registered information is transmitted to each related processing unit.

### [Operation of Disaster Response Training Device 10]

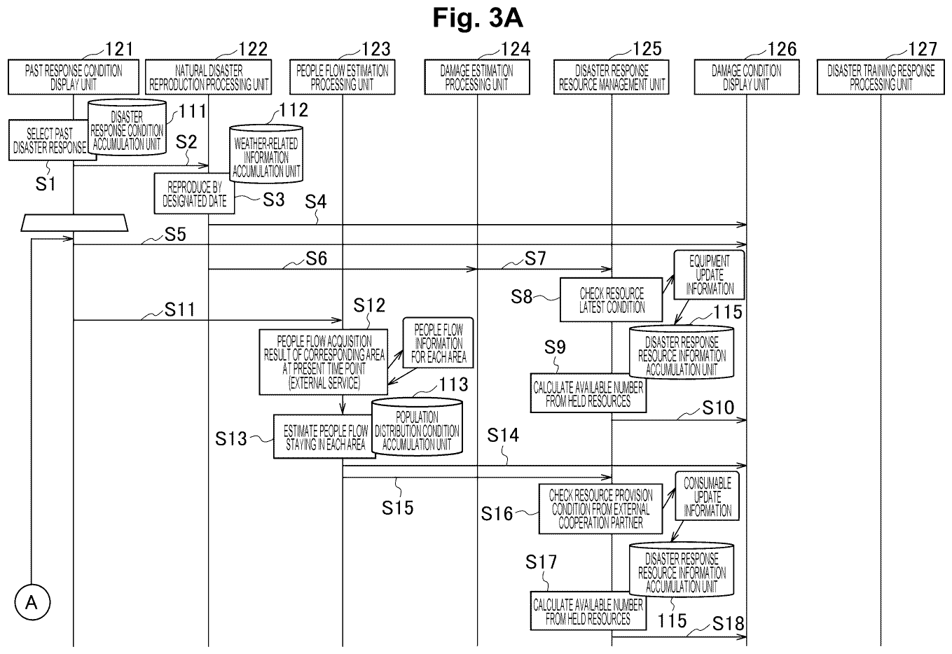

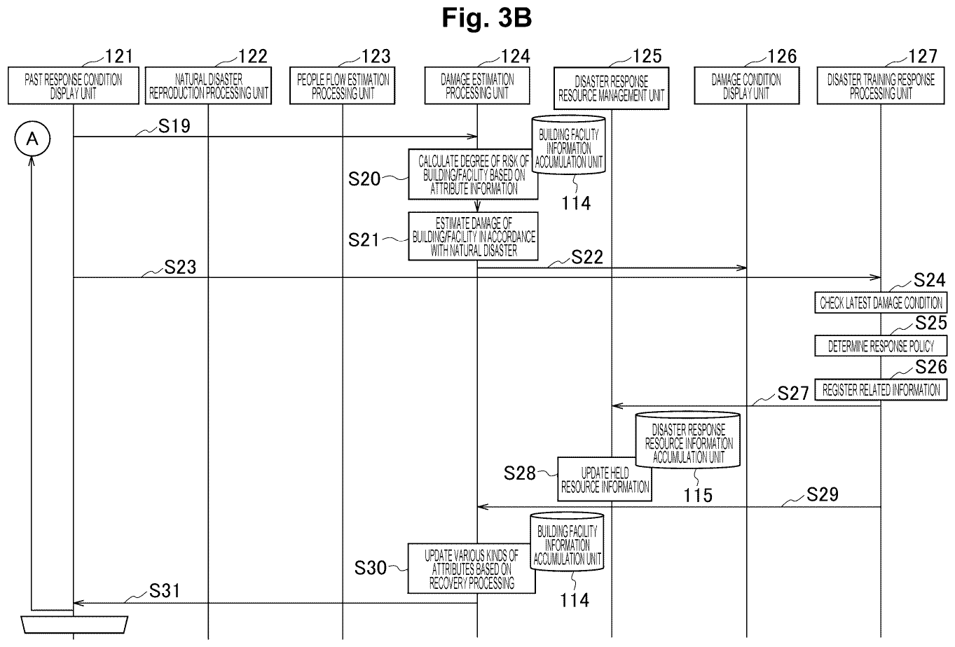

FIG. 3 is a view indicating processing flow of the disaster response training device 10. The disaster response training device 10 executes the following processing when disaster response training is started.

### Step S1;

The past response condition display unit 121 acquires a plurality of scenarios from the disaster response condition accumulation unit 111 and selects a predetermined scenario designated by the staff of the local government from the acquired plurality of scenarios. The scenario is information in which the type, date of occurrence, response time point, damage condition, response policy, and the like, of a natural disaster having occurred in the past are collected for each event (for each response time point) and stored in time series.

### Step S2;

The past response condition display unit 121 transmits a natural disaster reproduction request for reproducing the natural disaster of the selected scenario to the natural disaster reproduction processing unit 122.

### Step S3;

In response to the received natural disaster reproduction request, the natural disaster reproduction processing unit 122 acquires the weather-related information matching the date and time point of occurrence of the selected scenario from the weather-related information accumulation unit 112 and reproduces the natural disaster using the acquired weather-related information.

### Step S4;

The natural disaster reproduction processing unit 122 transmits a natural disaster reproduction result display request for displaying the reproduction result of the reproduced natural disaster to the damage condition display unit 126. In response to the received natural disaster reproduction result display request, the damage condition display unit 126 displays the reproduction result of the past natural disaster included in the selected scenario on the screen.

### Step S5;

The past response condition display unit 121 sets a time point of the event 1 described at the top of the selected scenario as a start time point and transmits an event display request for displaying information regarding the event 1 at the start time point to the damage condition display unit 126. In response to the received event display request, the damage condition display unit 126 displays various types of information stored in the row of the event 1 included in the selected scenario on the screen.

### Step S6;

The natural disaster reproduction processing unit 122 transmits the reproduction result of the natural disaster to the damage estimation processing unit 124.

### Step S7;

The damage estimation processing unit 124 transmits a resource information calculation request for calculating disaster response resources to the disaster response resource management unit 125 according to the received reproduction result of the natural disaster.

### Step S8;

In response to the received resource information calculation request, the disaster response resource management unit 125 checks the latest condition of the disaster response resources in the management area of the local government from the disaster response resource management unit 125. For example, the disaster response resource management unit 125 checks the lending condition and return condition of equipment in a predetermined evacuation center in the managed area.

### Step S9;

The disaster response resource management unit 125 calculates the number of disaster response resources available in the management area of the local government at the present time point on the basis of the checked latest condition of the disaster response resources. For example, the disaster response resource management unit 125 calculates the available number of pieces of equipment in a predetermined evacuation center in the managed area.

### Step S10;

The disaster response resource management unit 125 transmits an available resource information display request for displaying the calculated number of available disaster response resources to the damage condition display unit 126. In response to the received available resource information display request, the damage condition display unit 126 displays the number of disaster response resources available in the management area of the local government at the present time point on the screen.

### Step S11;

The past response condition display unit 121 transmits a people flow information acquisition request for estimating the population staying in the management area of the local government at the present time point to the people flow estimation processing unit 123.

### Step S12;

In response to the received people flow information acquisition request, the people flow estimation processing unit 123 acquires inflow population and outflow population to and from each area (by town and block) in the management area of the local government using position information of mobile terminals, and the like. Specifically, the people flow estimation processing unit 123 acquires the inflow population and the outflow population to and from first street of town A, second street of town A, first street of town B, . . . .

### Step S13;

The people flow estimation processing unit 123 calculates the estimated number of people staying in each area at the present time point on the basis of the acquired inflow population and outflow population to and from each area and a population distribution condition of each area acquired from the population distribution condition accumulation unit 113.

### Step S14;

The people flow estimation processing unit 123 transmits a people flow estimation result display request for displaying the estimation result of the calculated number of staying people to the damage condition display unit 126. In response to the received people flow estimation result display request, the damage condition display unit 126 displays the estimated number of people staying for each town and block at the present time point on the screen.

### Step S15;

The people flow estimation processing unit 123 transmits the calculated estimated number of staying people in each area to the disaster response resource management unit 125.

### Step S16;

The disaster response resource management unit 125 checks a condition where the disaster response resources are provided to each area from the local government or the business operator that is an external cooperation partner according to the received estimated number of staying people in each area. For example, the disaster response resource management unit 125 checks a condition where consumables are provided from the external cooperation partner to a predetermined area in the management area.

### Step S17;

The disaster response resource management unit 125 calculates the number of available disaster response resources in each area at the present time point on the basis of the confirmed condition where the disaster response resources are provided. For example, the disaster response resource management unit 125 calculates the available number of consumables in a predetermined area in the management area.

### Step S18;

The disaster response resource management unit 125 transmits an available resource information display request for displaying the calculated number of available disaster response resources to the damage condition display unit 126. In response to the received available resource information display request, the damage condition display unit 126 displays the number of disaster response resources available in the management area of the local government at the present time point on the screen.

### Step S19;

The past response condition display unit 121 transmits, to the damage estimation processing unit 124, a building facility risk degree acquisition request for calculating the influence on buildings and facilities in the management area of the local government.

### Step S20;

In response to the received building facility risk degree acquisition request, the damage estimation processing unit 124 acquires construction facility information of buildings and facilities provided in the management area of the local government from the building facility information accumulation unit 114 and calculates degrees of risk of buildings and facilities on the basis of attribute information of buildings, and the like, included in the acquired construction facility information. For example, the damage estimation processing unit 124 calculates a collapse rate of a predetermined building in the management area by using the number of years, a building structure, and repair time of the predetermined building.

### Step S21;

The damage estimation processing unit 124 calculates the estimated damage degree of the building or the facility due to the past natural disaster on the basis of the calculated degree of risk of the building or the facility and the reproduction result of the natural disaster received in step S6. For example, the damage estimation processing unit 124 calculates a collapse rate of a predetermined building having the calculated degree of risk collapsing due to flooding of a river that has occurred in the past.

### Step S22;

The damage estimation processing unit 124 transmits a building facility damage estimation result display request for displaying the calculated damage estimation result of the buildings and facilities to the damage condition display unit 126. In response to the received building facility damage estimation result display request, the damage condition display unit 126 displays the estimated degrees of damage of the buildings and facilities in the management area due to the past natural disaster on the screen.

### Step S23;

The past response condition display unit 121 transmits a confirmation request of the event 1 for confirming the information regarding the event 1 in the selected scenario to the disaster training response processing unit 127.

### Step S24;

The disaster training response processing unit 127 causes the staff of the local government to confirm reproduction information of the past natural disaster, various information of the event 1 for the natural phenomenon, the estimated number of people staying in each town and block at the present time point, estimated damage of buildings and facilities due to the natural disaster, and the number of available disaster response resources at the present time point. For example, the disaster training response processing unit 127 displays a message prompting confirmation processing on the screen.

### Step S25;

The disaster training response processing unit 127 causes the staff of the local government to request and determine the current response policy of the event 1 on the basis of the estimated number of people staying at the present time point, and the like, using various kinds of information (scenarios) of the event 1 as a basis of the response policy. For example, the disaster training response processing unit 127 displays a message prompting determination processing of the current response policy on the screen.

### Step S26;

The disaster training response processing unit 127 registers the determined response policy and necessary information in accordance with the response policy. For example, the disaster training response processing unit 127 stores, in the disaster response condition accumulation unit 111, a response policy for the event 1 determined by the staff of the local government.

### Step S27;

In a case where the staff of the local government determines to use the disaster response resources, the disaster training response processing unit 127 transmits a resource information update request for updating the disaster response resources to the disaster response resource management unit 125.

### Step S28;

In response to the received resource information update request, the disaster response resource management unit 125 updates a condition of the held disaster response resources stored in the disaster response resource information accumulation unit 115.

### Step S29;

The disaster training response processing unit 127 transmits a building facility attribute information update request for updating various attribute information of buildings and facilities to the damage estimation processing unit 124 on the basis of the response policy determined in step S25.

### Step S30;

In response to the received building facility attribute information update request, the damage estimation processing unit 124 calculates the strength and the degrees of risk after recovery processing based on the response policy is performed, calculates the estimated damage after the recovery processing is performed, calculates various attribute information of the buildings and the facilities after the recovery processing is performed and updates the building facility information accumulation unit 114 with the calculation results.

### Step S31;

The damage estimation processing unit 124 transmits that the processing of the event 1 has been completed to the past response condition display unit 121.

Thereafter, the disaster response training device 10 executes processing similar to that in steps S5 to S31 for an event 2 in the selected scenario. The disaster response training device 10 repeatedly executes this processing up to the last event in the selected scenario. Each functional unit (the natural disaster reproduction processing unit 122 to the disaster training response processing unit 127) constituting the disaster response training device 10 executes processing for each event (each response time point) in the scenario on the same time axis as the time axis of the scenario.

### Effects

According to the present embodiment, the disaster response training device 1 includes: a past response condition display unit 121 that processes damage caused by a past disaster that has occurred in a predetermined area and a response policy as a scenario; a people flow estimation processing unit 123 that calculates a current number of people staying in the predetermined area; a damage estimation processing unit 124 that calculates current damage to real estate in the predetermined area; a disaster response resource management unit 125 that calculates current disaster response resources in the predetermined area; a damage condition display unit 126 that displays, on a screen, the disaster response policy by the past disaster, the current number of people staying, the current damage to the real estate, and the current disaster response resources; and a disaster training response processing unit 127 that requests a user to provide a current response policy based on the current number of people staying in the predetermined area, the current damage to the real estate, and the current disaster response resources, so that it is possible to provide a technique capable of performing disaster response training in a state close to the current condition and providing disaster response training in a form close to reality.

The conditions of people, buildings, and facilities or the conditions of resources change according to the condition at the time of training, and thus, the disaster response resources that can be used for the damage condition and the recovery are different even if the past disaster response is the same. On the other hand, according to the present embodiment, the condition to be presented each time of training is different, and thus, the training responder can work without being accustomed to the training.

In particular, the number of staying people at the training time point is estimated on the basis of the people flow service, and thus, the training can be performed in a form close to damage assumed to occur in the current condition.

In particular, the past damage condition and the policy for responding to the past damage condition are displayed at the time of training, so that it is possible to utilize know-how of the predecessors when considering the response policy. Even if the event is not the same as the past event, the past event can be used as a reference for disaster response, and also plays a role of taking over technique of the response policy.

In addition, according to the present embodiment, the damage estimation processing unit 124 calculates a degree of risk of real estate on the basis of a material, a structure, aging, a geographical condition, and a type of disaster of the real estate and calculates damage to the real estate on the basis of the degree of risk, so that it is possible to perform training in a form close to damage assumed to occur in the current condition, and it is possible to provide a technique capable of providing disaster response training in a form closer to reality.

Furthermore, according to the present embodiment, the damage estimation processing unit 124 calculates damage to the real estate on the basis of the past disaster, so that it is possible to provide a technique capable of providing disaster response training in a form further closer to reality.

Furthermore, according to the present embodiment, the people flow estimation processing unit 123, the damage estimation processing unit 124, the disaster response resource management unit 125, the damage condition display unit 126, and the disaster training response processing unit 127 execute processing for each response time point on the same time axis as the time axis of the scenario, so that it is possible to provide a technique capable of providing disaster response training in a form further closer to reality.

### Application Example

The disaster response training device 10 is intended for training, but can also be used as a disaster response device when a disaster actually occurs in a condition where a scenario is not called. By recording the response conditions in time series, it can also be used as a scenario for next training.

### Others

The present invention is not limited to the above embodiment. The present invention may be modified in various manners within the gist of the present invention.

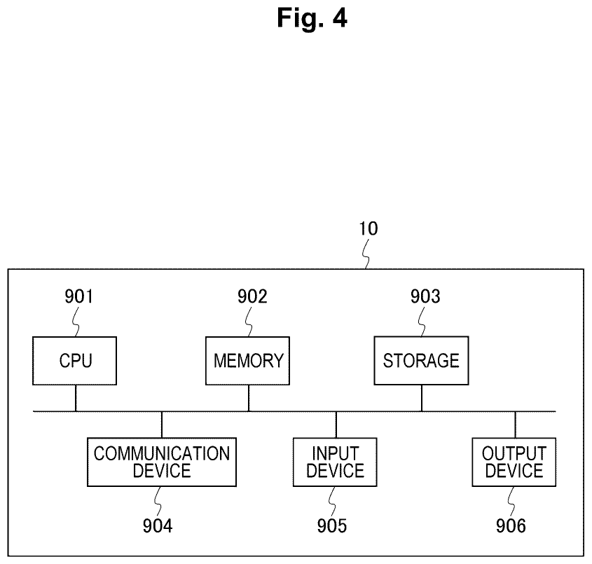

For example, as illustrated in FIG. 4, the disaster response training device 10 of the present embodiment described above can be implemented using a general-purpose computer system including a CPU 901, a memory 902, a storage 903, a communication device 904, an input device 905, and an output device 906. The memory 902 and the storage 903 are storage devices. In the computer system, each function of the disaster response training device 10 is implemented by the CPU 901 executing a predetermined program loaded on the memory 902.

The disaster response training device 10 may be implemented by a 1 computer. The disaster response training device 10 may be implemented by a plurality of computers. The disaster response training device 10 may be virtual machine to be implemented on a computer. The program for the disaster response training device 10 can be stored in a computer-readable recording medium such as an HDD, an SSD, a USB memory, a CD, or a DVD. The program for the disaster response training device 10 can also be distributed via a communication network.

### REFERENCE SIGNS LIST

1 Disaster response training system
10 Disaster response training device
11 Storage unit
111 Disaster response condition accumulation unit
112 Weather-related information accumulation unit
113 Population distribution condition accumulation unit
114 Building facility information storage unit
115 Disaster response resource information accumulation unit
116 Map information accumulation unit
12 Control unit
121 Past response condition display unit
122 Natural disaster reproduction processing unit
123 People flow estimation processing unit
124 Damage estimation processing unit
125 Disaster response resource management unit
126 Damage condition display unit
127 Disaster training response processing unit
20 Client terminal
30 Communication network
901 CPU
902 Memory
903 Storage
904 Communication device
905 Input device
906 Output device

1. A disaster response training device comprising:
a processing unit, including one or more processors, configured to process damage caused by a past disaster having occurred in a predetermined area and a response policy as a scenario;
a first calculation unit, including one or more processors, configured to calculate a current number of people staying in the predetermined area;
a second calculation unit, including one or more processors, configured to calculate current damage to real estate in the predetermined area;
a third calculation unit, including one or more processors, configured to calculate current disaster response resources in the predetermined area;
a display unit, including one or more processors, configured to display, on a screen, the damage caused by the past disaster and the response policy, the current number of people staying, the current damage to the real estate, and the current disaster response resources; and
a request unit, including one or more processors, configured to request a user to provide a current response policy based on the current number of people staying, the current damage to the real estate, and the current disaster response resources on a basis of the response policy of the scenario.

2. The disaster response training device according to claim 1, wherein the second calculation unit includes a degree of risk of real estate on a basis of a material, a structure, aging and a geographical condition of the real estate, and a type of disaster and calculates damage to the real estate on a basis of the degree of risk.

3. The disaster response training device according to claim 1, wherein the second calculation unit calculates damage to the real estate on a basis of the past disaster.

4. The disaster response training device according to claim 1, wherein
the scenario is a scenario in which changing damage caused by the past disaster and the response policy are stored in time series for each response time point, and
the first calculation unit, the second calculation unit, the third calculation unit, the display unit, and the request unit execute processing for each response time point on the same time axis as the time axis of the scenario.
